(19) United States
(12) Patent Application Publication
(10) Pub. No.: US 2007/0152838 A1
(43) Pub. Date: Jul. 5, 2007

(54) Tool or fastening member or the like capable of emitting natural signal

(76) Inventor: Chih-Ching Hsieh, Feng Yuan City (TW)

Correspondence Address: TROXELL LAW OFFICE PLLC, SUITE 1404, 5205 LEESBURG PIKE, FALLS CHURCH, VA, 22041, US

(21) Appl. No.: 11/324,406

(22) Filed: Jan. 4, 2006

(51) Int. Cl. G08B 17/12; G08B 1/08

(52) U.S. Cl. 340/600; 340/539.32

(57) ABSTRACT

An article capable of naturally emitting a signal for easily searching the article. The article can be a tool, an accessory of a tool, a fastening member or the like. A signal element is mounted on the article to be searched. The signal element itself is able to naturally emit a detectable signal, whereby the article to be searched will automatically emit a signal for easily searching and locating the article to be searched.

### BACKGROUND OF THE INVENTION

The present invention is related to a tool, an accessory of a tool, a mechanical part, a fastening member or the like, and more particularly to a mechanical article capable of naturally emitting a signal for easily searching the article or judging whether the article is truly installed. The article can be a tool or a fastening member such as a screw or a rivet.

There are various complicated and sophisticated apparatuses such as aircrafts, boats, power vehicles, etc. For example, an airplane engine includes numerous parts. In case any of these parts is not truly installed, for example, in case an important screw or gasket is not tightened in a specific position, the complicated apparatus may fail. The apparatus must be periodically maintained and the parts of the apparatus must be periodically replaced. When serviced, it is necessary to disassemble numerous parts and reassemble these parts. Therefore, it is quite time-consuming and laborious to maintain the complicated apparatus. In the case that any of the parts is incautiously not installed, the complicated apparatus may fail to result in danger. Therefore, it is quite important to install all the parts of aircrafts, boats, power vehicles, etc. in their true positions and no risk is allowed. However, it is very hard to ensure that every specific part of the complicated apparatus is truly installed and assembled.

Furthermore, the complicated apparatus is maintained or repaired in a large-size factory. The tools (such as wrenches, sockets, screwdrivers, etc.) and parts (such as screws, gaskets, etc.) are scattered around. Some tools or parts are easy to miss or hard to find. This leads to delay of service work. Also, when a worker goes back after leaving the working site, the worker often fails to find the necessary tools or parts.

Therefore, it is tried by the applicant to provide a measure enabling a worker to easily judge whether a specific part is truly installed and to quickly find a specific tool or part, especially with respect to a highly sophisticated apparatus requiring high security.

### SUMMARY OF THE INVENTION

It is therefore a primary object of the present invention to provide a tool or a fastening member or the like capable of emitting natural signal for easily searching the tool or fastening member or judging whether the part is installed in a true position.

The present invention can be best understood through the following description and accompanying drawings.

### BRIEF DESCRIPTION OF THE DRAWINGS

FIG. 1 is a perspective view of a first embodiment of the present invention;

FIG. 2 is a side partially sectional view of a second embodiment of the present invention;

FIG. 3 is a side partially sectional view of a third embodiment of the present invention;

FIG. 4 is a perspective view of a fourth embodiment of the present invention; and

FIG. 5 is a perspective view of a fifth embodiment of the present invention.

### DETAILED DESCRIPTION OF THE PREFERRED EMBODIMENTS

The subject of the present invention can be a tool such as a wrench, a screwdriver and a pincers or an accessory of a tool, such as a socket or a fastening member such as a screw, a nut, a gasket, a C-shaped retainer and a rivet.

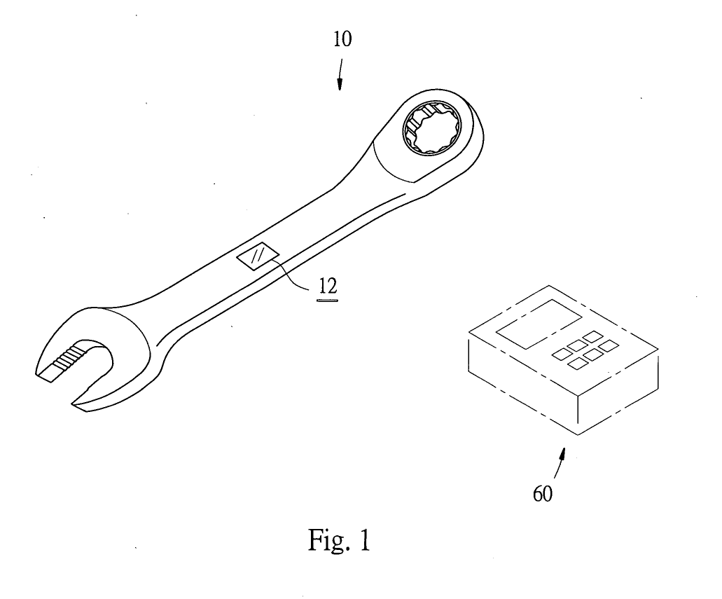

FIG. 1 shows a wrench 10 which is exemplified. A signal element 12 is mounted on the wrench 10. The signal element 12 is an element which can automatically emit a signal of a certain wavelength. Practically, the signal element can be made of quartz or radium or any other material which can automatically emit a signal of a certain wavelength.

With quartz or radium exemplified, quartz itself can emit a signal of a fixed frequency. Radium is a low radiant material, which can also emit a signal of a fixed frequency. Radium has high stability so that the radiation of radium will not cause any harm to human body. In the present invention, the radiation of radium is strictly controlled within a safety range. Accordingly, quartz and radium both lastingly stably emit a natural signal of a certain wavelength. In other words, the signal element of the present invention itself can naturally emit a signal of a certain frequency or wavelength without using external power or energy.

The signal element of the present invention is a material made of naturally existing material or artificially extracted material. Such a material can be used as the signal element as long as the material can automatically emit a fixed frequency of signal without using external energy, such as electromagnetic wave and radiant wave, and the signal can be detected or received.

The quarts or radium described in the specification can be formed with various shapes. For example, it can be a thin sheet, a cylindrical body or a rectangular member, and it is mounted on an article to be searched.

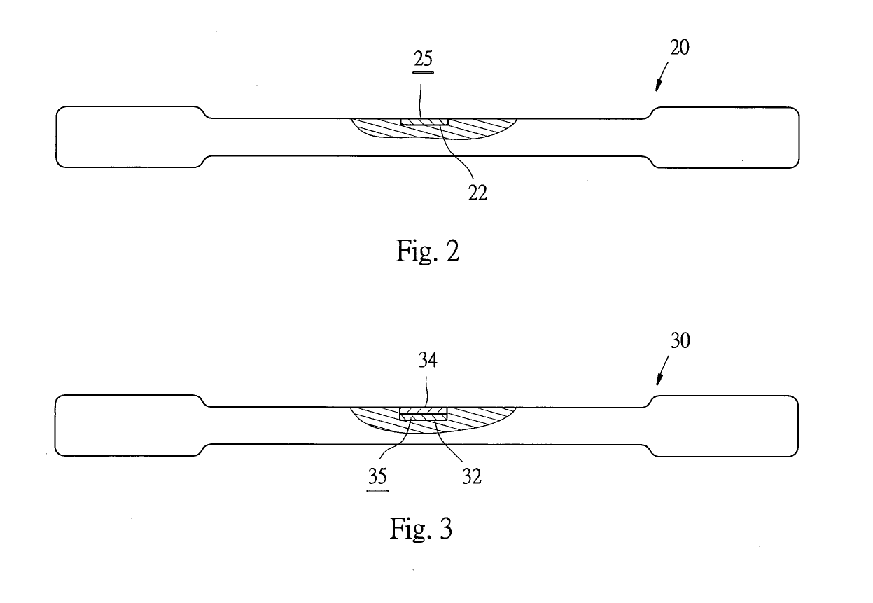

The signal element 12 can be attached to the surface of the wrench 10. Alternatively, as shown in FIG. 2, the signal element 25 can be embedded in a recess 22 of the wrench 20 and exposed to the surface of the wrench. Alternatively, as shown in FIG. 3, the signal element 35 can be mounted in a recess 32 of the wrench 30 and a protective cover 34 is inlaid in the recess 32 to cover the element. The protective cover will not affect transmission of the signal of the signal element.

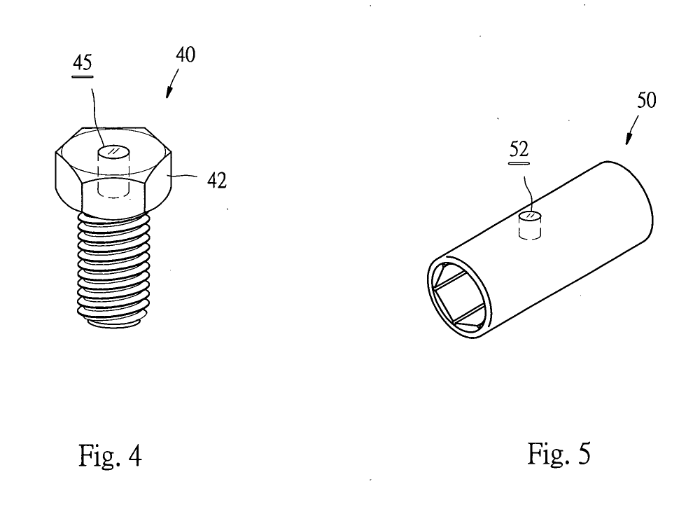

The subject of the present invention can be also a screw 40 as shown in FIG. 4. A signal element 45 is inlaid in the head section 42 of the screw 40. Alternatively, as shown in FIG. 5, a signal element 52 can be mounted in a socket 50 to be searched.

The signal elements 12, 25, 35, 45 or 52 can emit a certain signal. Therefore, an article equipped with the signal element can outward emit a signal. A detection device 60 such as a detector or a receiver can detect the signal for searching and locating the article.

It is easy to judge whether an important fastening member such as the screw 40 equipped with the signal element is installed in a specific position. For example, with respect to a complicated sophisticated apparatus having numerous parts, after maintained or serviced, it is uneasy to ensure that a certain screw is installed. This is because the important screw is often tightened inside the apparatus and invisible. Conventionally, it is necessary to re-disassemble the apparatus for insurance. However, in the present invention, the important screw is equipped with the signal element so that by means of the detection device, the screw can be located to judge whether the screw is installed in the apparatus. Accordingly, it can be conveniently and precisely checked whether the important component is installed without consuming much time.

Moreover, in a large-size service site, when working on a large and complicated apparatus, it is uneasy to find an important part or tool among widely distributed parts and tools. However, according to the present invention, it is easy to detect and locate a specific part or tool equipped with the signal element by means of a detector.

According to the above arrangement, the present invention enables a user to judge whether a specific article is truly installed so as to ensure safety in use of a sophisticated apparatus. Also, a specific article can be quickly found and located.

The above embodiments are only used to illustrate the present invention, not intended to limit the scope thereof. Many modifications of the above embodiments can be made without departing from the spirit of the present invention.

What is claimed is:

1. A tool or a fastening member or the like capable of emitting natural signal, comprising:
an article to be searched, such as a tool, an accessory of a tool or a fastening member, said tool or fastening member being characterized in that further comprising:
a signal element mounted on the article to be searched, the signal element itself being able to naturally emit a signal of a certain wavelength, whereby the article to be searched will automatically emit a signal for easily locating the article to be searched.

2. The tool or fastening member or the like as claimed in claim 1, wherein the signal element is able to naturally emit a signal of a certain frequency.

3. The tool or fastening member or the like as claimed in claim 1, wherein the signal element is able to emit an electromagnetic wave.

4. The tool or fastening member or the like as claimed in claim 1, wherein the signal element is able to radiate low radiation.

5. The tool or fastening member or the like as claimed in claim 1, wherein the signal element is disposed on a surface of the article to be searched.

6. The tool or fastening member or the like as claimed in claim 1, wherein a surface of the article to be searched is formed with a recess and the signal element is inlaid in the recess.

7. The tool or fastening member or the like as claimed in claim 6, further comprising a protective cover inlaid in the recess to cover the signal element.

8. The tool or fastening member or the like as claimed in claim 1, wherein the signal element is made of quartz.

9. The tool or fastening member or the like as claimed in claim 1, wherein the signal element is made of radium.
